(19) United States
(12) Patent Application Publication
(10) Pub. No.: US 2026/0067976 A1
(43) Pub. Date: Mar. 5, 2026

(54) INFORMATION PROCESSING APPARATUS, METHOD FOR INFORMATION PROCESSING APPARATUS, AND STORAGE MEDIUM

(71) Applicant: CANON KABUSHIKI KAISHA, Tokyo (JP)

(72) Inventor: YUICHI YAGI, Tokyo (JP)

(21) Appl. No.: 19/311,590

(22) Filed: Aug. 27, 2025

(30) Foreign Application Priority Data
Sep. 5, 2024 (JP) 2024-153051

(51) Int. Cl. H04W 76/20; H04W 24/08

(52) U.S. Cl. CPC H04W 76/20; H04W 24/08

(57) ABSTRACT

An information processing apparatus includes at least one memory that stores a program and at least one processor that executes the program to execute, based on a communication characteristic of a target device, estimation of a use environment of the device, notify a user of a result of the estimation of the use environment of the device, and check a connection state of a network interface of the device. In a situation where it is determined that the connection state of the network interface is an unconnected state, the estimation is executed in a case where an execution instruction is received from a user, and the estimation is stopped in a case where a stop instruction is received from the user.

### BACKGROUND

### Field of the Technology

The present disclosure relates to an information processing apparatus, a method for an information processing apparatus, and a storage medium.

### Description of the Related Art

As a security measure, it is desirable that various security-related functions of information devices are set appropriately. In recent years, the environments in which information devices are used have become more diverse. It is desirable that the devices be used after the change to the settings suited to the use environment.

Japanese Patent Application Laid-Open No. 2019-22099 describes a technology for supporting security policy updates by linking and managing a preset security policy and the characteristics of the network operating status, and detecting changes in the characteristics of the network operating status.

Japanese Patent Application Laid-Open No. 2016-66212 describes a technology for detecting a new network communication interface and configuring security settings to restrict the use of services.

However, with these conventional technologies, security settings are configured as a new interface is detected, so that services available with the previous connection interface may become unavailable, resulting in poor usability for users.

### SUMMARY

In view of the above issue, the present disclosure is directed to enabling a target device to be used in a more suitable manner depending on each situation, even if the device can be used in a variety of environments.

According to an aspect of the present disclosure, an information processing apparatus includes at least one memory that stores a program and at least one processor that executes the program to execute, based on a communication characteristic of a target device, estimation of a use environment of the device, notify a user of a result of the estimation of the use environment of the device, and check a connection state of a network interface of the device. In a situation where it is determined that the connection state of the network interface is an unconnected state, the estimation is executed in a case where an execution instruction is received from a user, and the estimation is stopped in a case where a stop instruction is received from the user.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating an example of a system configuration of an information processing system.

FIG. 2 is a diagram illustrating an example of an internal configuration of a controller unit of a multifunction peripheral (MFP).

FIG. 3 is a diagram illustrating an example of a software configuration of the MFP.

FIGS. 4A to 4E are diagrams illustrating examples of screens displayed on an operation unit of the MFP.

FIGS. 5A to 5C are diagrams illustrating examples of screens displayed on the operation unit of the MFP.

FIG. 6 is a flowchart illustrating an example of processing by the MFP.

FIG. 7 is a flowchart illustrating an example of processing by the MFP.

FIG. 8 is a flowchart illustrating an example of processing by the MFP.

FIG. 9 is a flowchart illustrating an example of processing by the MFP.

### DESCRIPTION OF THE EMBODIMENTS

Exemplary embodiments of the present disclosure will be described in detail with reference to the accompanying drawings.

In the specification and drawings, like reference numerals refer to like components having substantially the same functional configuration, and redundant description thereof will be omitted.

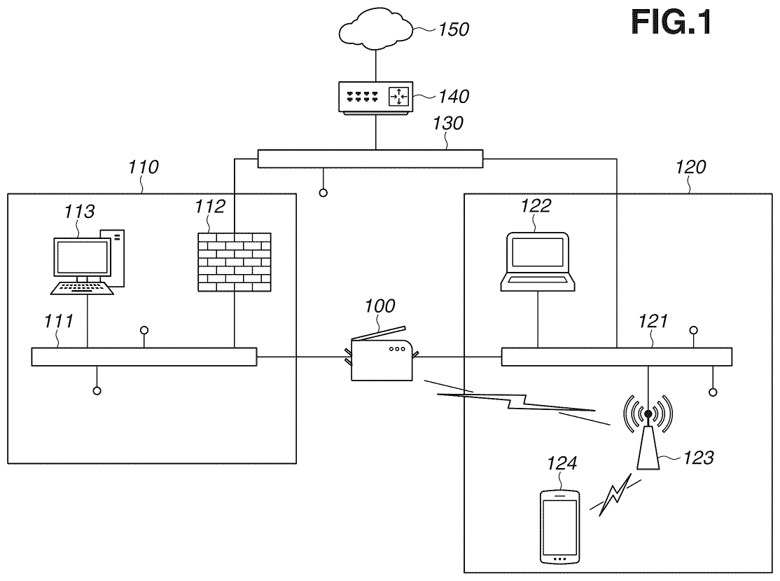

An example of a system configuration of an information processing system according to the present exemplary embodiment will be described with reference to FIG. 1. Specifically, the example illustrated in FIG. 1 is an example of a connection form between a multifunction peripheral (MFP), a gateway, a firewall, a wireless local area network (LAN) access point personal computer (PC), a mobile terminal, and the Internet according to the present exemplary embodiment.

An MFP 100 includes two wired LAN interfaces and a wireless LAN interface. The two wired LAN interfaces of the MFP 100 are connected to a LAN 111 in a network 110 and a LAN 121 in a network 120. The wireless LAN interface of the MFP 100 is connected to a wireless LAN access point 123 in the network 120. The network connection in the present exemplary embodiment refers to a link-up state in which communications with devices in networks are available.

In contrast, in the present exemplary embodiment, a state of being unconnected to a network or a state of being disconnected from a network refers to a link-down state in which communications with devices in networks are restricted.

The networks 110 and 120 are connected to a LAN 130, and are connected to the Internet 150 via a gateway 140.

A firewall 112 is installed in the network 110 to configure an isolated network in which communications with the Internet 160 and external networks are restricted. Communications of a PC 113 are restricted to devices connected within the network 110.

The network 120 is configured such that a PC 122 and a wireless LAN access point 123 are connected to the LAN 121, and a mobile terminal 124 is connected to the wireless LAN access point 123. The network 120 is connectable to the Internet 150, and communicable with devices such as a server (not illustrated) connected to the Internet 150.

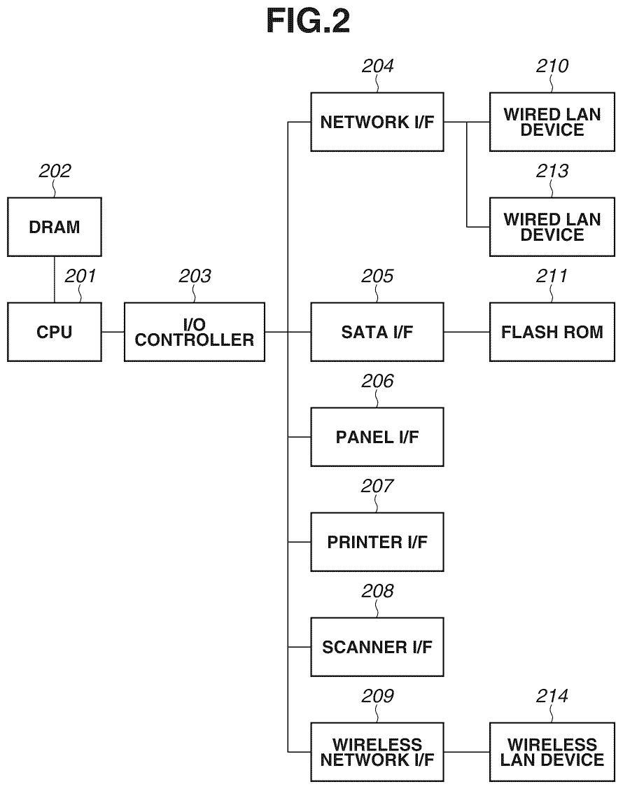

An example of an internal configuration of a controller unit of the MFP 100 will be described with reference to FIG. 2.

A central processing unit (CPU) 201 performs main arithmetic processing in the controller unit of the MFP 100.

The CPU 201 is connected to a dynamic random access memory (DRAM) 202 via a bus. The DRAM 202 is used by the CPU 201 as a working memory for temporarily holding program data representing arithmetic instructions, data to be processed, and the like, during arithmetic operations performed by the CPU 201.

The CPU 201 is connected to an input/output (I/O) controller 203 via a bus. The I/O controller 203 controls input/output to and from various devices according to instructions from the CPU 201.

A serial advanced technology attachment (SATA) interface (I/F) 205 is connected to the I/O controller 203, and a flash read only memory (ROM) 211 is connected to the SATA I/F 205. The CPU 201 uses the flash ROM 211 as a storage area for permanently storing programs for implementing the functions of the MFP and document files.

A network I/F 204 is connected to the I/O controller 203. Wired LAN devices 210 and 213 are connected to the network I/F 204. The CPU 201 controls the wired LAN device 210 via the network I/F 204 to conduct communications with other devices connected to the LAN 111, and controls the wired LAN device 213 to conduct communications with other devices connected to the LAN 121.

A wireless LAN device 214 is connected to a wireless network I/F 209. The CPU 201 controls the wireless LAN device 214 via the wireless network I/F 209 to connect to the wireless LAN access point 123 to conduct communications with other devices connected to the LAN 121 and communications with the mobile terminal 124. Hereinafter, the wired LAN devices 210 and 213 and the wireless LAN device 214 will each also be referred to as a LAN device.

A panel I/F 206 is connected to the I/O controller 203, and the CPU 201 controls the operation unit 102 via the panel I/F 206 to output information to a user and to receive input from the user.

A printer I/F 207 is connected to the I/O controller 203, and the CPU 201 controls the printer unit 103 via the printer I/F 207 to perform output processing on paper media.

As a specific example, in the case of performing a copy function, the CPU 201 reads program data from the flash ROM 211 into the DRAM 202 via the SATA I/F 205. The CPU 201 detects a copy instruction from the user to the operation unit 102 via the panel I/F 206 in accordance with the program read into the DRAM 202. On the detection of the copy instruction, the CPU 201 receives an original document as electronic data from the scanner unit 104 via a scanner I/F 208 and stores the electronic data in the DRAM 202. The CPU 201 performs color conversion processing and the like suitable for output on the image data stored in the DRAM 202.

The CPU 201 transfers the image data stored in the DRAM 202 to the printer unit 103 via the printer I/F 207, and executes output processing based on the image data onto a paper medium.

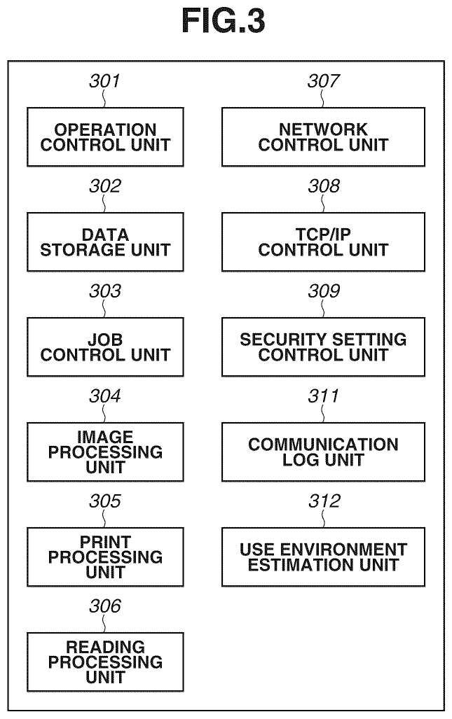

An example of a software configuration of the MFP 100 will be described with reference to FIG. 3. The software is executed by the controller unit 101, for example, after the program stored in the flash ROM 211 is read into the DRAM 202 by the CPU 201.

An operation control unit 301 executes processing related to display of a screen image for a user on the operation unit 102, and processing associated with detection of a user operation and screen components, such as buttons, displayed on the screen.

A data storage unit 302 receives requests from other control units to store data in the flash ROM 211 and read data from the flash ROM 211. For example, in response to receipt of an instruction from a user to change some device setting, the operation control unit 301 detects the content input by the user to the operation unit 102. In addition, in response to a request from the operation control unit 301, the data storage unit 302 saves the content input by the user in the flash ROM 211 as a setting value.

A job control unit 303 performs control related to job execution in accordance with instructions from other control units.

An image processing unit 304 processes the target image data into a format suitable for each use in accordance with an instruction from the job control unit 303.

A print processing unit 305 prints an image on a paper medium via the printer I/F 207 in accordance with an instruction from the job control unit 303, and outputs the result as a printed product.

A reading control unit 306 reads an original document placed on a platen via the scanner I/F 208 in accordance with an instruction from the job control unit 303.

A network control unit 307 configures network settings, such as an Internet Protocol (IP) address, for a Transmission Control Protocol (TCP)/IP control unit 308 in response to system startup, detection of a setting change, or the like, in accordance with the setting values stored in the data storage unit 302. The network control unit 307 also enables or disables a LAN device based on the settings of the MFP 100.

The TCP/IP control unit 308 executes transmission and reception processing of network packets via the network I/F 204 and the wireless network I/F 209 in accordance with instructions from other control units.

A security setting control unit 309 manages the correspondence between the use environment, such as a corporate LAN, a home, a public space, or an isolated network, and the security-related setting items for the use environment. In response to receipt of a specification of the use environment from the user, the security setting control unit 309 may collectively set the corresponding security-related setting information. The security setting control unit 309 uses the data storage unit 302 to refer to and change the setting values. The security setting control unit 309 may collectively set the corresponding security-related setting information if use environment estimation described below is executed in accordance with an instruction from the user.

A communication log extraction unit 311 uses the network control unit 307 to extract communication logs transmitted and received by the MFP 100. As a specific example, the communication log extraction unit 311 may extract information, such as destination and source IP addresses, TCP/User Datagram Protocol (UDP) type, port number, and IP header information, from information accompanying network packets. When the communication log extraction unit 311 executes the extraction processing, a content portion of the packet called a payload is excluded, for example.

A use environment estimation unit 312 estimates the use environment from the communication logs extracted by the communication log extraction unit 311. The use environment is estimated based on a pattern shown in Table 1, for example. For example, the use environment estimation unit 312 extracts the communication logs of the wired LAN devices 210 and 213 and the wireless LAN device 214, and estimates the use environment based on the communication logs. If the results of use environment estimation for individual LAN devices are different, the use environment estimation unit 312 may employ the result with higher recommended priority. The method for setting the recommended priority for each use environment is not particularly limited, and the recommended priority may be set such that higher priority is given to a use environment with the most functional restrictions due to recommended security settings, for example.

TABLE 1

| Use | | Recommended |
|---|---|---|
| environment | Overview | priority order |
| Corporate | General office environment | 3 |
| LAN | | |
| Isolated | Isolated network prohibiting | 4 |
| network | connection to the Internet | |
| Home | Home network for working at home | 2 |
| Public space | Open space where an unspecified large | 1 |
| | number of people enter and exit, | |
| | and share a network | |

The use environment shown as the corporate LAN corresponds to a general office environment, and is assumed to be an environment where many people gather and internet connectivity is established for their accessing some cloud services, for example. The use environment shown as the corporate LAN includes the largest number of information devices connected compared with the other use environments. In this environment, a managed firewall is generally installed at the boundary with the external network, and access to the area where each information device is installed is restricted to related parties, such as company members. Due to such characteristics, the use environment shown as the corporate LAN uses security measures implemented on the use environment side and security measures implemented on each terminal in a well-balanced manner. In the present exemplary embodiment, the use environment shown as the network 120 in FIG. 1 is the use environment shown as the corporate LAN.

The use environment shown as the isolated network is assumed to be an environment in which the connection to the Internet is cut off as a network topology due to some reason, such as the use of an old protocol, and the network is used as an isolated network. The use environment shown as the isolated network has a relatively small number of information devices connected compared with the other use environments. In this environment, strong security measures are implemented on the use environment side, making it possible to relax the level of security measures to be implemented on the terminal side. In the present exemplary embodiment, the use environment shown as the network 110 in FIG. 1 is the use environment shown as the isolated network.

The use environment shown as home corresponds to a home network intended for telecommuting, and is assumed to be an environment in which a small-scale LAN used at home is used as it is for work at home. The use environment shown as home has the fewest number of information devices connected compared with the other use environments. In this environment, it may be required to take balanced security measures on the terminal side, on the assumption that security measures on the use environment side cannot be relied on as much as in the other use environments.

The use environment shown as public space is assumed to be an open space where an unspecified large number of people enter and exit, and share the network. Examples of the use environment shown as public space include airport lounges and co-working spaces available for guest use, where entry restrictions are less strict than in the other use environments and the number of information devices connected is relatively large compared with the other use environments. In this environments, it is generally desirable not to trust the security measures implemented on the use environment side, and it is desirable to implement security measures on the terminal side even if some functionality is sacrificed.

Specifically, the use environment estimation unit 312 analyzes communication logs based on the information shown in Table 2.

TABLE 2

| Communication log attributes | Overview |
|---|---|
| Traffic volume | Proportional to the number of devices |
| | that make up the network |
| Number of destination | Proportional to the number of external |
| addresses | services used by devices |
| Number of transmitting | Proportional to the number of devices |
| source addresses | that make up the network |
| Number of types of | Proportional to trends in device usage |
| protocols used | |
| Variation of Time To | Corresponding to the distance between |
| Live (TTL) attribute | terminals that make up the network |
| in IP header | |

The traffic volume is the number of communication packets transmitted and received per unit time. The data (packets) that can be received by a device connecting to a network is data transmitted by unicast communication addressed to the device, or data transmitted by broadcast or multicast without specifying any destination address. The broadcast and multicast traffic volume increases in proportion to the number of information devices present in the use environment of the target device, and is thus information that can be used to estimate the size of the network to which the device is connected. In order to more clearly identify the size of the network, data (packets) transmitted by unicast communication may be excluded from the measurement of the traffic volume. Depending on the size of the traffic volume, it is possible to estimate which of the use environments is relatively more likely to be, a large-scale company intranet, a medium-scale public space, or a small-scale home environment.

The number of destination addresses is the number of variations of addresses that are the destinations of communication packets transmitted and received per unit time. The number of destination addresses tends to be larger due to use of a variety of external services by the target device. Due to this characteristic, if the number of destination addresses is extremely small, the use environment is highly likely to be an isolated network, where communication is restricted.

The number of transmitting source addresses is the number of variations of addresses that were used as the transmitting source of communication packets transmitted and received per unit time. If there are a large number of information devices in the network to which the target device is connected, the number of transmitting source addresses tends to be larger. The number of transmitting source addresses exhibits a trend similar to the traffic volume. Since the two have essentially different values, observing the trend in combination with the traffic volume makes it possible to further improve the accuracy of estimating the use environment.

The number of protocol types is the number of protocol variations used by the communication packets transmitted and received per unit time. With more information devices connected to the target network (that is, the network to which the target device is connected), the number of protocol types tends to be greater. In a network environment in which stricter functional restrictions are applied, the number of protocol types tends to be a relatively small value. Due to this characteristic, if the value of the number of protocol types is relatively small, the use environment is highly likely to be an isolated network or a public space.

The variation of the Time To Live (TTL) attribute in IP header refers to the variation of TTL values accompanying the communication packets transmitted and received per unit time. Since the variation of the TTL attribute in IP header corresponds to values that are each decremented each time the corresponding packet passes through a router, packets that pass via more routers have smaller values upon arrival. Due to this characteristic, an environment in which the variation of the TTL attribute in IP header uniformly assumes large values is highly likely to correspond to a small-scale network. On the other hand, an environment in which the variation of the TTL attribute in IP header includes large values to small values is highly likely to correspond to a large-scale network.

In consideration of the above characteristics, the use environment estimation unit 312 estimates the use environment by evaluating each of the parameters exemplified above with respect to thresholds set according to features, such as the network scale.

Communication logs can have an apparent tendency (characteristic) according to the use environment. If it is difficult to logically determine a threshold for estimating the use environment, it is possible to improve the estimation accuracy of the use environment by compositely determining the threshold through combination of a plurality of parameters. For example, the processing related to the estimation of the use environment by the use environment estimation unit 312 can be implemented by a model trained based on machine learning using a combination of the use environment and communication logs obtained in the same use environment as learning data.

Whether the network is an Internet-connectable network, such as LAN 120, or an isolated network, such as LAN 110, can be determined based on whether the IP address of the communication source is within the range of private addresses.

When analyzing communication logs, the use environment estimation unit 312 saves the execution history for each LAN device, as shown in Table 3 below, in the flash ROM 211 as the use environment estimation history. For a LAN device for which the use environment estimation unit 312 has executed a use environment estimation, the result of the estimation is saved as a history, and for a LAN device for which the estimation has not been executed, a history indicating that the device is unconnected is saved. If the state of a LAN device changes from a state of being connected to the network to a state of being unconnected to the network, the information saved as the use environment estimation history is also changed to indicate a state of being unconnected. In an initial state in which the use environment estimation has not been executed, a history indicating that the use environment estimation has not been executed is saved as the use environment estimation history.

TABLE 3

| LAN devices | Use environment estimation history |
|---|---|
| Wired LAN1 | Corporate LAN |
| Wired LAN2 | Unconnected |
| Wireless LAN | Corporate LAN |

In the present exemplary embodiment, the security-related settings controlled by the security setting control unit 309 include settings in common among LAN devices and settings for the main network and the sub-network independently. In the following description, the main network will also be referred to as the main line, and the sub-network will also be referred to as the sub-line. In the present exemplary embodiment, the main line is assumed to be used mainly, such as for connecting to a core system within a company, and the wired LAN device 210 and the wireless LAN device 214 are assigned to the main line. The sub-line is assumed to be used in an expanded manner depending on the application, and the wired LAN device 213 is assigned to the sub-line.

The security-related setting policy differs among a series of use environments shown in Table 1. For that reason, the security setting control unit 309 checks the environment selected by the user against the setting table for estimated environments shown in Table 4 below, and performs security-related settings based on the results. For settings that are optional in the setting table shown in Table 4, settings, such as on or off, are not applied, and the current setting values are not changed.

TABLE 4

| Setting | | Setting | Setting | Corporate | Isolated | | Public |
|---|---|---|---|---|---|---|---|
| type | | target | item | LAN | network | Home | space |
| Common | | Encryption | Transport | On | Any | On | On |
| | | of | Layer | | | | |
| | | communication | Security | | | | |
| | | path | (TLS) | | | | |
| | | | setting | | | | |
| | | Legacy | Windows | Off | Any | Off | Off |
| | | Protocol | Internet | | | | |
| | | | Name | | | | |
| | | | Service | | | | |
| | | | (WINS) | | | | |
| | | | setting | | | | |
| | | Authentification | Proibiting | Prohibited | Any | Prohibited | Prohibited |
| | | | caching of | | | | |
| | | | authentication | | | | |
| | | | password | | | | |
| | | | for | | | | |
| | | | external | | | | |
| | | | server | | | | |
| | | | Set the | 8 | Any | 8 | 8 |
| | | | minimum | characters | | characters | characters |
| | | | password | | | | |
| | | | length | | | | |
| | | Physical | Hard disk | Any | Any | On | On |
| | | attack | complete | | | | |
| | | countermeasure | erasure | | | | |
| | | | setting | | | | |
| | | File sharing | Server | Any | Any | Off | Off |
| | | function | Message | | | | |
| | | | Block | | | | |
| | | | (SMB) | | | | |
| | | | Server | | | | |
| | | | Setting | | | | |
| | | External | Use | Off | Off | Off | Off |
| | | storage | Universal | | | | |
| | | device | Serial Bus | | | | |
| | | | (USB) | | | | |
| | | | external | | | | |
| | | | storage | | | | |
| | | | device | | | | |
| Independent | Main | Personal | IP address | Any | Any | Rejection | Rejection |
| | line | firewall | filter | | | | |
| | | | default | | | | |
| | | | policy | | | | |
| | | | IP address | Any | Any | Subnet | Subnet |
| | | | filter | | | address | address |
| | | | exception | | | of | of |
| | | | address | | | device | device |
| | Sub- | | IP address | Any | Any | Rejection | Rejection |
| | line | | filter | | | | |
| | | | default | | | | |
| | | | policy | | | | |
| | | | IP address | Any | Any | Subnet | Subnet |
| | | | filter | | | address | address |
| | | | exception | | | of | of |
| | | | addresses | | | device | device |

Encryption of the communication path can be applied as a countermeasure against threats, such as leakage, tampering, and spoofing. For example, except for the isolated network type, in which connection to the Internet is restricted, there is a possibility that unspecified users can access the MFP 100 via the network. Thus, in the usage forms other than the isolated network type, it is desirable to enable the settings related to encryption of the communication path. An example of a function to implement encryption of the communication path is a communication encryption function using Transport Layer Security (TLS). The TLS setting is set to enabled in the environments other than the isolated network.

Disabling legacy protocols can be applied as a countermeasure against spoofing and leakage. For example, except for the isolated network type, in which connection to the Internet is restricted, there is a possibility that unspecified users can access the MFP 100 via the network. Thus, in the usage forms other than the isolated network type, it is desirable to enable the settings related to disabling legacy protocols in order to cut off unsafe access means. Examples of legacy protocols include the Windows Internet Name Service (WINS) protocol.

Authentication can be applied as a countermeasure against spoofing. For example, it is desirable to enable a function of authenticating users and terminals accessing the network, except for the isolated network type, which prioritizes connectivity within the isolated network. Examples of authentication-related settings include prohibiting password caching and specifying the minimum number of characters for passwords.

Physical attack countermeasures can be applied as countermeasures against leakage. For example, in the home type or the public space type, where physical access to the MFP 100 is difficult to restrict, it is desirable to implement countermeasures against physical attacks by enabling the settings related to physical attack countermeasures. Examples of the settings related to physical attack countermeasures include a hard disk complete erasure function to completely delete data that is no longer necessary on the hard disk.

Disabling a file sharing function can be applied as a countermeasure against leakage in a case where an unspecified large number of users share and use a network. For example, it is desirable to disable the settings related to the file sharing function except for the environments having a private network. Thus, it is recommended to disable the file sharing function except for the corporate LAN type, the isolated network type, and the home type, for example. Examples of the settings related to the file sharing function includes a Server Message Block (SMB) server setting.

Disabling external storage devices can be applied as a countermeasure against leakage. An example of the setting related to external storage devices is a setting as to whether to use a Universal Serial Bus (USB) storage device as an external storage device. The threat of data leakage via a USB storage device can be common to all of the use environments. Thus, it is desirable to disable that setting in all of the use environments.

Enabling a personal firewall can be applied as a countermeasure against leakage and denial of service (DoS) attacks. For example, except for the isolated network type, in which connection to the Internet is restricted, and the corporate LAN type protected by a firewall, there is a possibility that unspecified users can access the MFP 100 via a network. Thus, in the usage forms other than the isolated network type and the corporate LAN type, it is desirable to implement access control by enabling the setting(s) related to a personal firewall. An example of a personal firewall is a function, such as an IP address filter or a port number filter, which permits or denies access only to specific IP addresses or communication ports. IP address settings and the like are not common between the main line and the sub line, so independent settings are applied separately.

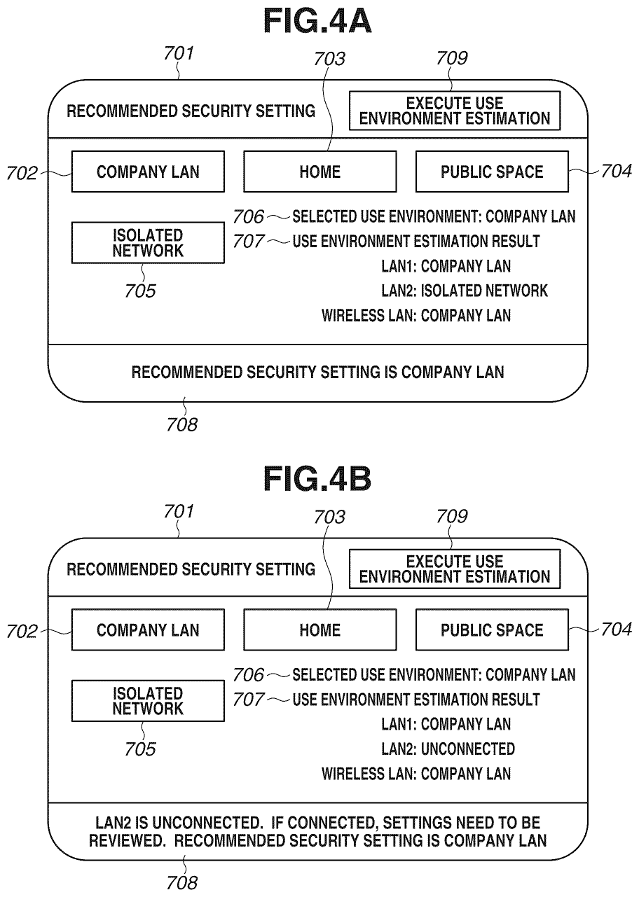

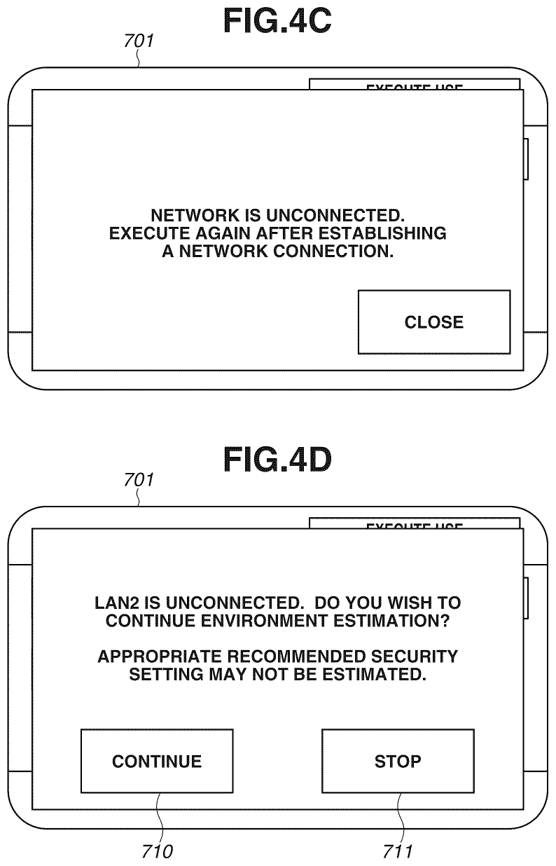

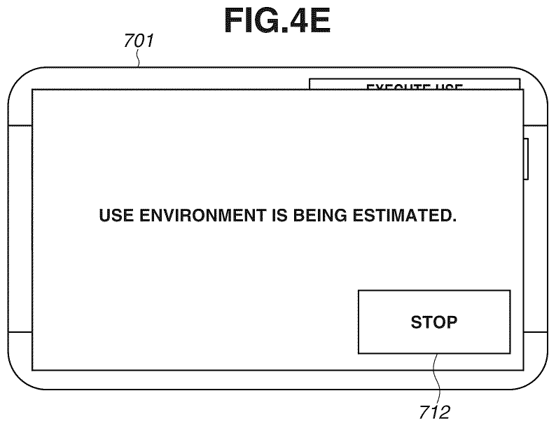

A recommended security setting screen 701 will be described as an example of a screen displayed on the operation unit 102 with reference to FIG. 4.

A use environment corporate LAN button 702 is a button for collectively making a series of security settings appropriate in a case where the use environment is a corporate LAN. A use environment home button 703 is a button for collectively making a series of security settings appropriate in a case where the use environment is home. A use environment public space button 704 is a button for collectively making a series of security settings appropriate in a case where the use environment is a public space. An isolated network button 705 is a button for collectively making a series of security settings appropriate in a case where the use environment is an isolated network.

A display area 706 is an area where information indicating the use environment set via the button 702, 703, 704, or 705 is displayed as the selected use environment information. When the button corresponding to the target use environment is pressed, the information indicating which pattern has been selected as the use environment is saved in the data storage unit 302 in association with date and time information indicating when the button was pressed.

A display area 707 is an area where information indicating the use environment estimated in the estimation process from the tendency of communication data about the LAN device is displayed as the estimated result of the use environment. If the network is unconnected, the display area 707 displays that fact.

A display area 708 is an area where information for making various types of notifications to the user is displayed.

FIG. 4A is a display example in a case where the isolated network is selected as the recommended security setting. In the example illustrated in FIG. 4A, LAN1 (the wired LAN device 210) is a corporate LAN, LAN2 (the wired LAN device 213) is an isolated network, and WIRELESS LAN (the wireless LAN device 214) is a corporate LAN, and this information is displayed in the display area 707. Thus, in accordance with the recommended priority order shown in Table 1, a message indicating that the recommended security setting is a corporate LAN is displayed in the display area 708.

FIG. 4B is a display example in a case where the corporate LAN is selected as the recommended security setting with the wired LAN device 213 unconnected. In the example illustrated in FIG. 4B, LAN1 is the corporate LAN, LAN2 is unconnected, and WIRELESS LAN is the corporate LAN, and this information is displayed in the display area 707. Thus, in accordance with the recommended priority order illustrated in Table 1, a message indicating that the recommended security setting is the corporate LAN is displayed in the display area 708. Also, in the example illustrated in FIG. 4B, since LAN2 is unconnected, a message is displayed in the display area 708 urging the user to reconsider the recommended security setting when LAN2 becomes connected.

A use environment estimation execution button 709 is used for causing the communication log extraction unit 311 to extract a communication log to cause the use environment estimation unit 312 to analyze the communication log and then execute use environment estimation. When the use environment estimation is started in response to a press of the use environment estimation execution button 709 and then is completed, the information displayed in the display area 707 is updated based on the result of the use environment estimation.

If the network control unit 307 determines that no LAN device is connected to the network at the time of execution of the use environment estimation, the screen illustrated in FIG. 4C is displayed. If the network control unit 307 determines that some of the LAN devices are connected to the network and the other devices are unconnected, the screen illustrated in FIG. 4D is displayed. If the network control unit 307 determines that all of the LAN devices are connected to the network, the screen illustrated in FIG. 4E is displayed.

FIG. 4C is a screen that prompts the user to connect to a network. FIG. 4D is a screen that asks the user whether to continue the use environment estimation. When a continue button 710 is pressed, the current screen transitions to the screen illustrated in FIG. 4E, and when a stop button 711 is pressed, the current screen returns to the screen illustrated in FIG. 4A. FIG. 4E is a screen that illustrates the use environment estimation in progress. When the use environment estimation is completed or a stop button 712 is pressed, the current screen returns to the screen illustrated in FIG. 4A.

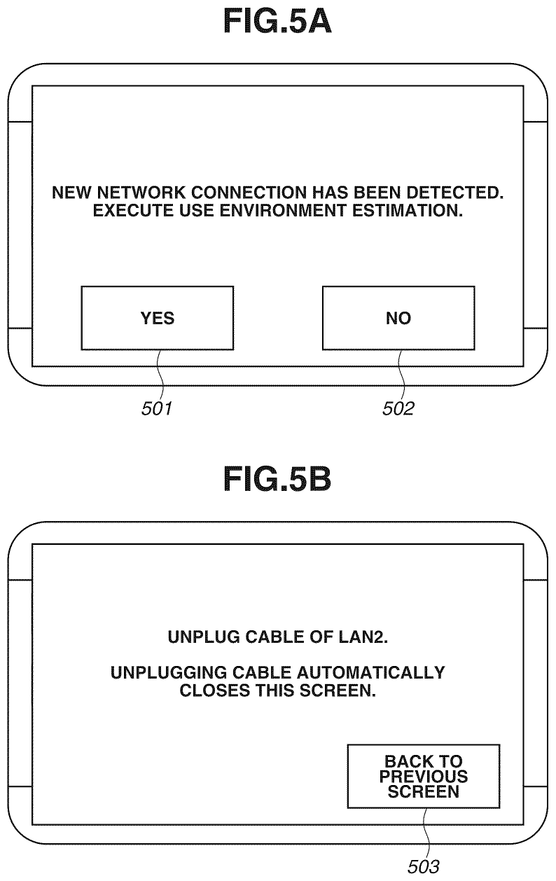

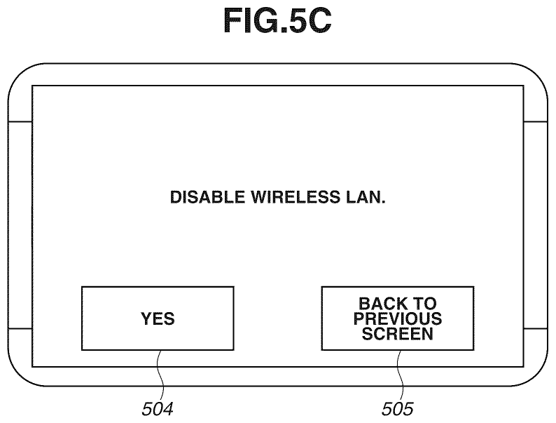

As example of a screen displayed on the operation unit 102, an example will be described of a screen displayed when a network connection is detected with a history of unconnected state saved in the use environment estimation history with reference to FIG. 5.

If a yes button 501 is pressed on the screen illustrated in FIG. 5A, the same process is executed as in the case where the use environment estimation execution button 709 in FIG. 4A is pressed. On the other hand, if a no button 502 is pressed on the screen illustrated in FIG. 5A, the transition of the screen is controlled depending on whether the network-connected LAN device is the wired LAN device 210 or 213, or the wireless LAN device 214.

If the network-connected device is the wired LAN device 210 or 213, the screen illustrated in FIG. 5B is displayed. In this state, if the LAN cable is unplugged from the target LAN device, the current screen transitions to a screen not illustrated that was displayed before the screen illustrated in FIG. 5A. On the other hand, if a back button 503 is pressed on the screen illustrated in FIG. 5B, the current screen returns to the screen illustrated in FIG. 5A.

If the network-connected LAN device is the wireless LAN device 214, the screen illustrated in FIG. 5C is displayed. In this state, if a yes button 504 is pressed, the network control unit 307 disables the wireless LAN to disconnect the network. Then, if a back button 505 is pressed, the current screen returns to the screen illustrated in FIG. 5A.

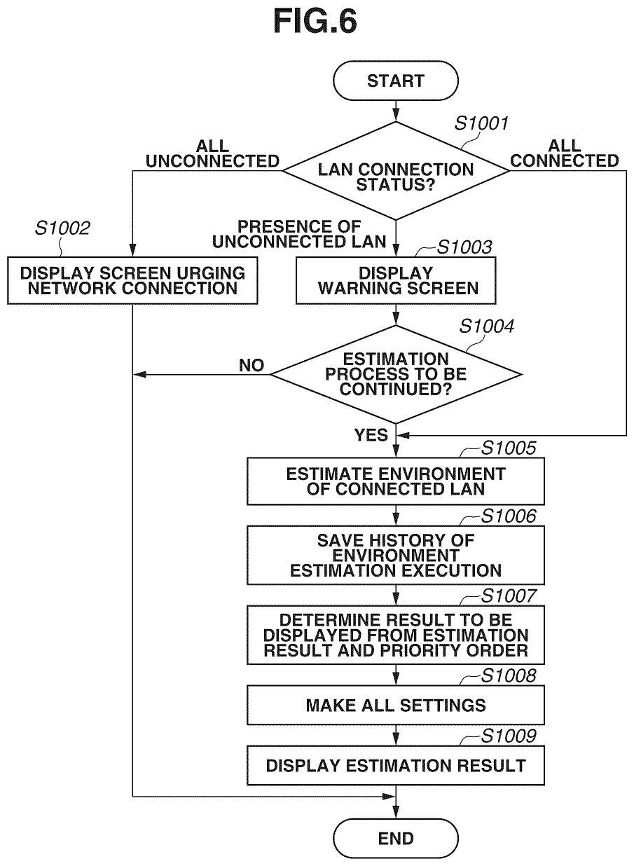

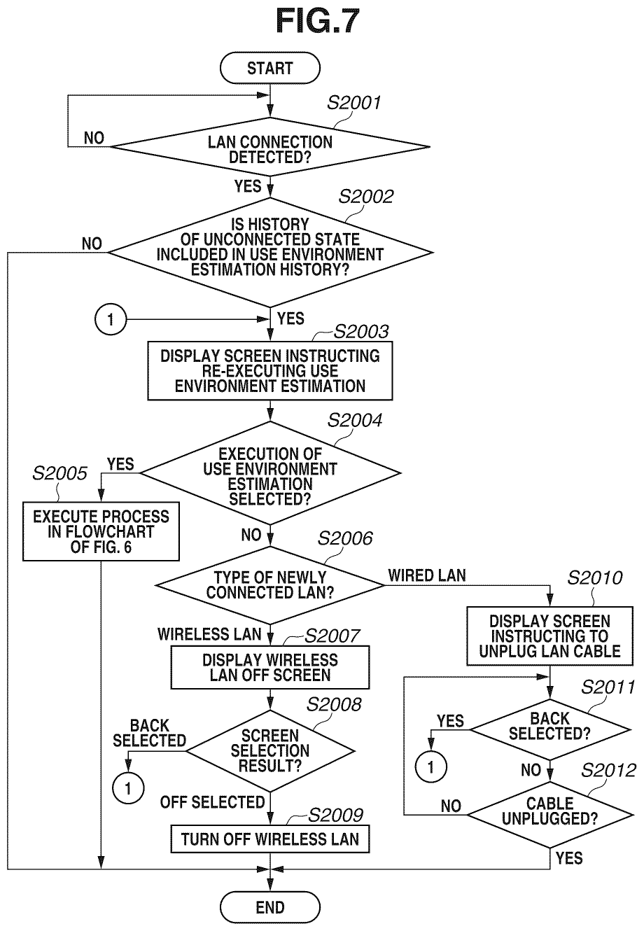

An example of processing performed by the MFP 100 according to the present exemplary embodiment will be described with reference to FIG. 6, focusing on processing of executing the use environment estimation by the MFP 100 in response to receipt of an instruction from the user. A series of processing steps illustrated in FIG. 6 are executed by the use environment estimation unit 312 in response to receipt of an instruction from the network control unit 307 and the communication log extraction unit 311. In effect, the CPU 201 reads programs from the flash ROM 211 into the DRAM 202 and executes the programs, implementing the series of processing steps illustrated in FIG. 6.

In step S1001, the MFP 100 checks the network connection status. The LAN devices to be checked in step S1001 have been enabled by the network control unit 307. That is, the LAN device(s) intentionally disabled by the user is or are excluded from the check target(s) in step S1001.

If the MFP 100 determines in step S1001 that all of the LAN devices to be checked are unconnected (ALL UNCONNECTED in step S1001), the processing proceeds to step S1002.

If the MFP 100 determines in step S1001 that some of the LAN devices to be checked are connected to the network and the remaining devices are unconnected (PRESENCE OF UNCONNECTED LAN in step S1001), the processing proceeds to step S1003.

If the MFP 100 determines in step S1001 that all of the LAN devices to be checked are connected to the network (ALL CONNECTED IN step S1001), the processing proceeds to step S1005.

In step S1002, the MFP 100 displays the screen illustrated in FIG. 4C, and the series of processing steps illustrated in FIG. 6 is ended.

In step S1003, the MFP 100 displays the screen illustrated in FIG. 4D.

In step S1004, the MFP 100 receives a user operation via the screen displayed in step S1003 to switch between the subsequent processing steps in response to the user operation.

Specifically, if the MFP 100 determines in step S1004 that the continue button 710 has been pressed (YES in step S1004), the processing proceeds to step S1005.

On the other hand, if the MFP 100 determines in step S1004 that the stop button 711 has been pressed (NO in step S1004), the series of processing steps illustrated in FIG. 6 is ended.

In step S1005, the MFP 100 estimates use environments of the LAN devices already connected to the network. Specifically, as described above, the communication log extraction unit 311 uses the network control unit 307 to extract a communication log transmitted and received by the MFP 100. Then, the use environment estimation unit 312 estimates which of the use environment patterns shown in Table 1 corresponds to the communication log extracted by the communication log extraction unit 311.

In step S1006, the MFP 100 saves the history of the use environment estimation executed in step S1005. At this time, information indicating the state of being unconnected to the network is saved in the histories of the LAN devices unconnected to the network, and the results of the use environment estimation executed in step S1005 are saved in the histories of the LAN devices connected to the network. Information indicating the unconnected state is also saved in the histories of the disabled LAN devices. After the use environment estimation, when a LAN device is enabled and connected to the network, the LAN device becomes the target of processing in step S2002 described below. This makes it possible to avoid a situation where the LAN device continues to be used by the user without execution of the use environment estimation.

In step S1007, the MFP 100 selects recommended security settings based on the results of the use environment estimation executed in step S1005. At this time, if the results of the use environment estimation in step S1005 are different among the individual LAN devices, the MFP 100 selects recommended security settings in accordance with the recommended priority order shown in Table 1. On the other hand, if the results of the use environment estimation in step S1005 are consistent across all the LAN devices, the MFP 100 selects security settings that correspond to the results of the use environment estimation.

In step S1008, the MFP 100 collectively sets the items set in “Common” as setting type in the security-related settings shown in Table 4 in accordance with the results of the security setting selection in step S1007. For the setting items of independent setting types, the MFP 100 collectively configures the settings corresponding to the result of the use environment estimation for each LAN device in step S1005.

In step S1009, the MFP 100 displays recommended security settings in the display area 708 based on the results of the security setting selection in step S1007, and the series of processing steps illustrated in FIG. 6 is ended.

In the example illustrated in FIG. 6, all the settings are configured automatically. However, the processing in step S1008 may be skipped and then the estimation results may be notified to the user.

As described above, in response to receipt of an instruction from a user to execute the network use environment estimation, if there is an unconnected network, the MFP 100 notifies the user of the fact and executes the use environment estimation at the user's discretion. By applying such control to establish a network connection later, the use environment will be reviewed, so that it can be expected to reduce the probability of restriction of the use of a function that was previously available.

As a security measure, it is desirable for various security-related functions of information devices to be set appropriately. If an information device is used in a single fixed environment, settings adapted to the single fixed use environment will be applied at the time of shipment allows the user to use the information device with appropriate security measures without particular awareness.

On the other hand, the use environments of information devices have become more diverse in recent years. For example, focusing on the use environments of multifunction peripherals, office environments were mostly used with robust perimeter defenses in both physical and network-interface aspects. In contrast, the proportion of new usage patterns, such as use in home and use in public spaces shared by an unspecified large number of people, has been increasing in recent years. In such environments, it is desirable to, before using the devices, change the settings of the devices from the default settings made at the time of shipment for office environments to those suited to the use environment.

For example, on the assumption that perimeter defenses are in place in office environments, it may be desirable to prioritize convenience to permit connections to a management console via a network.

On the other hand, in public spaces, where there is no perimeter defense and the risk of attack is high, it is desirable to prohibit this connection in some cases. In this manner, the appropriate security settings may differ depending on the use environment, and it thus is necessary to change the settings when the use environment changes.

In addition, some information devices, such as multifunction peripherals, which have a plurality of interfaces, such as a wired LAN and a wireless LAN, and can enable these interfaces simultaneously to use. Such information devices can be assumed to be shared in a variety of use environments. For example, one interface of those information devices may be connected to a general office environment, and another interface may be connected to an isolated network, where users are restricted and connection to the Internet is restricted.

As described above, in the case of detection of a connection of a new interface or change of the setting(s) of an existing connection interface in an information device having a plurality of interfaces, it is desirable to change the settings of the other interface(s) as well in some cases. For example, if a new connection is established from an isolated network to an information device used in a general office environment, the security settings of the general office environment can be assumed to be not desirable as the security settings of the isolated network. In view of such a situation, if security settings are configured in response to the detection of a new interface, services that were available with the previous connection interface may become unavailable, resulting in poor usability for users.

According to the present technique, it can be expected to produce the effect of reducing the probability of the use of a previously available function being restricted as a result of the review of the use environment.

An example of processing performed by the MFP 100 according to the present exemplary embodiment will be described with reference to FIG. 7, focusing on the processing in which the MFP 100 detects a network connection and then requests the user to re-execute the use environment estimation based on the execution history of the use environment estimation. The series of processing steps illustrated in FIG. 6 is executed by the use environment estimation unit 312 issuing an instruction to the network control unit 307. In effect, the CPU 201 reads programs from the flash ROM 211 into the DRAM 202 and then executes the programs, implementing a series of processing steps illustrated in FIG. 7.

In step S2001, the MFP 100 determines whether a network connection of a LAN device has been detected.

Unless a network connection of a LAN device is detected in step S2001, the MFP 100 continues to monitor a network connection of a LAN device.

If the MFP 100 determines in step S2001 that a network connection of a LAN device has been detected (YES in step S2001), the processing proceeds to step S2002.

In step S2002, the MFP 100 determines whether the history of the use environment estimation saved in step S1006 illustrated in FIG. 6 includes a history of unconnected state.

If the MFP 100 determines in step S2002 that the saved history of use environment estimation includes a history of unconnected state (YES in step S2002), the processing proceeds to step S2003.

On the other hand, if the MFP 100 determines in step S2002 that the saved history of use environment estimation does not include any history of unconnected state (NO in step S2002), the series of processing steps illustrated in FIG. 7 is ended.

A disabled LAN device is excluded from the determination in step S2002 even if the history of the use environment estimation indicates that the device was unconnected.

In step S2003, the MFP 100 displays the screen illustrated in FIG. 5A.

In step S2004, the MFP 100 switches between the subsequent steps in response to an operation received from the user via the screen displayed in step S2003.

Specifically, if the MFP 100 determines in step S2004 that the yes button 501 on the screen illustrated in FIG. 5A has been pressed (YES in step S2004), the processing proceeds to step S2005.

On the other hand, if the MFP 100 determines in step S2004 that the No button 502 on the screen illustrated in FIG. 5A has been pressed (NO in step S2004), the processing proceeds to step S2006.

In step S2005, the MFP 100 executes the series of processing steps illustrated in FIG. 6, and then the series of processing steps illustrated in FIG. 7 is ended.

In step S2006, the MFP 100 determines whether the type of the newly connected LAN device is a wired LAN or a wireless LAN.

If the MFP 100 determines in step S2006 that the type of the newly connected LAN device is a wireless LAN, that is, determines that the wireless LAN device 214 has been connected to the network, the processing proceeds to step S2007.

On the other hand, if the MFP 100 determines in step S2006 that the type of the newly connected LAN device is a wired LAN, that is, determines that either the wired LAN device 210 or 213 has been connected to the network, the processing proceeds to step S2010.

In step S2007, the MFP 100 displays the screen illustrated in FIG. 5C.

In step S2008, the MFP 100 switches between the subsequent processing steps in response to an operation received from the user via the screen displayed in step S2007.

Specifically, if the MFP 100 determines in step S2008 that the yes button 504 on the screen illustrated in FIG. 5C has been pressed, the processing proceeds to step S2009.

On the other hand, if the MFP 100 determines in step S2008 that the back button 505 on the screen illustrated in FIG. 5C has been pressed, the processing proceeds to step S2003. In this case, step S2003 and the subsequent steps are executed again.

In step S2009, the MFP 100 disables the wireless LAN to disconnect from the network under the control of the network control unit 307, and then the series of processing steps illustrated in FIG. 7 is ended.

In step S2010, the MFP 100 displays the screen illustrated in FIG. 5B for the LAN device (either the wired LAN device 210 or 213) whose network connection has been newly detected in step S2001. In that manner, the MFP 100 instructs the user to disconnect the LAN device from the network by unplugging the cable of the LAN device.

In step S2011, the MFP 100 determines whether the back button 503 on the screen displayed in step S2010 has been pressed.

If the MFP 100 determines in step S2011 that the back button 503 has been pressed (YES in step S2011), the processing proceeds to step S2003. In that case, the processing in step S2003 and the subsequent steps are executed again.

On the other hand, if the MFP 100 determines in step S2011 that the back button 503 is not being pressed (NO in step S2011), the processing proceeds to step S2012.

In step S2012, the MFP 100 determines whether the target LAN device (the LAN device whose network connection has been newly detected in step S2001) has become unconnected by unplugging of the LAN cable from the LAN device.

If the MFP 100 determines in step S2012 that the target LAN device is not unconnected (the LAN cable has not been unplugged) (NO in step S2012), the processing proceeds to step S2011.

In that case, the processing in step S2011 and the subsequent steps are executed again.

If the MFP 100 determines in step S2012 that the target LAN device has become unconnected (the LAN cable has been unplugged) (YES in step S2012), the series of processing steps illustrated in FIG. 7 is ended.

Applying the control described above makes it possible to avoid a situation in which, after a network connection is newly detected by the MFP 100, no use environment estimation is performed, or the MFP 100 is used by the user with the new network connection remaining established.

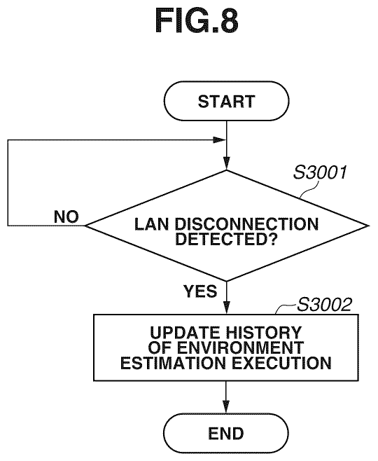

An example of processing performed by the MFP 100 will be described with reference to FIG. 8, focusing on the processing in which the MFP 100 detects a network disconnection and then updates the execution history of the use environment estimation. The series of processing steps illustrated in FIG. 8 is executed by the use environment estimation unit 312 in response to receipt of a notification from the network control unit 307. In effect, the CPU 201 reads programs stored in the flash ROM 211 into the DRAM 202 and executes the programs, implementing the series of processing steps illustrated in FIG. 8.

In step S3001, the MFP 100 determines whether a network connection of a LAN device has been detected.

Unless a network connection of a LAN device is detected in step S3001, the MFP 100 continues to monitor a network connection of a LAN device.

If the MFP 100 determines in step S3001 that a network connection of a LAN device has been detected (YES in step S3001), the processing proceeds to step S3002.

In step S3002, the MFP 100 checks the histories of use environment estimation of the disconnected LAN devices. If the estimation results are saved, the MFP 100 changes the histories to “unconnected state”. On the other hand, if information indicating the state before execution is saved in the histories of use environment estimation of the disconnected LAN devices, the MFP 100 does not change the histories. Then, the series of processing steps illustrated in FIG. 8 is ended.

As for disconnection of a LAN device, the user may intentionally change the network to which the device is to be connected. However, there may also be, for example, cases where the user briefly disconnect a wired LAN connection without intention or the power to a switching hub or a wireless LAN access point is turned off.

In view of such circumstances, it is also possible to perform control such that an instruction to re-execute the use environment estimation in step S2003 illustrated in FIG. 7 due to a disconnection of a LAN device unintended by the user is not issued. In that case, when the LAN device is disconnected, the MFP 100 changes the estimation history to “unconnected state” and leaves the previous estimation result. Then, in step S2003, through the automatic execution of the use environment estimation by, if the estimation result matches the previous result, the series of processing steps illustrated in FIG. 7 may be ended without executing the processing in step S2003.

Applying the above-described control makes it possible for the MFP 100 to instruct the user to execute the use environment estimation.

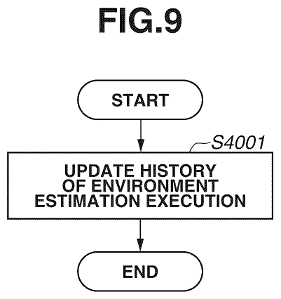

An example of processing performed by the MFP 100 will be described with reference to FIG. 9, focusing on the processing in which the MFP 100 starts up and updates the execution history of the use environment estimation. The series of processing steps illustrated in FIG. 9 are executed by the use environment estimation unit 312 before the network control unit 307 initializes a LAN device into a state in which a network connection can be detected. In effect, the CPU 201 reads programs stored in the flash ROM 211 into the DRAM 202 and then executes the programs, implementing the series of processing steps illustrated in FIG. 9. In addition, the start-up of the MFP 100 can be triggered by turning the power on and off or restarting the MFP 100, for example.

The series of processing steps illustrated in FIG. 9 is executed on the assumption that the use environment may change when the user changes the connection destination of the network cable while the power is off or during a restart, or when the network environment is changed, for example.

In step S4001, the MFP 100 checks the histories of use environment estimation of all LAN devices. Then, for LAN devices whose histories contain results of use environment estimation, the MFP 100 changes the histories to “unconnected state”. Further, for LAN devices whose histories contain information indicating the state of execution, the MFP 100 does not change the histories. Then, the series of processing steps illustrated in FIG. 9 is ended.

It is presumed that in many cases, the user has no choice but to turn the power off and on to restart the MFP 100.

In view of such circumstances, it is also possible to perform control such that an instruction to re-execute the use environment estimation in step S2003 illustrated in FIG. 7 is not issued. In this case, the MFP 100 changes the history of the use environment estimation to “unconnected state” and leaves the previous estimation result. Then, in step S2003, through the automatic execution of the use environment estimation by the MFP 100, if the estimation result matches the previous result, the series of processing steps illustrated in FIG. 7 may be ended without executing step S2003.

Applying the above-described control makes it possible for the MFP 100 to instruct the user to execute use environment estimation in response to turning the power on or off or restarting the MFP 100.

### Other Exemplary Embodiments

The technique can also be implemented by a process in which a program for implementing one or more functions of the above-described exemplary embodiment is supplied to a system or an apparatus via a network or a storage medium, and one or more processors in a computer of the system or apparatus read and execute the program. The present technique can also be implemented by a circuit (for example, an application specific integrated circuit (ASIC)) for implementing one or more functions.

Various modifications may be applied within the scope of the basic technical concept of each of the above-described exemplary embodiments of the present disclosure. For example, in each of the above-described exemplary embodiments, the application of the technique according to the present disclosure to an image forming apparatus has been described as an example, but the technique according to the present disclosure can be applied to general information processing apparatuses, not limited to image forming apparatuses.

According to the present disclosure, even if a target device can be used in a variety of environments, the device can be used in a more suitable manner depending on the situation at the time.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc™ (BD)), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-153051, filed Sep. 5, 2024, which is hereby incorporated by reference herein in its entirety.

What is claimed is:

1. An information processing apparatus comprising:
at least one memory that stores a program; and
at least one processor that executes the program to:
execute, based on a communication characteristic of a target device, estimation of a use environment of the device;
notify a user of a result of the estimation of the use environment of the device; and
check a connection state of a network interface of the device,
wherein in a situation where it is determined that the connection state of the network interface is an unconnected state, the estimation is executed in a case where an execution instruction is received from a user and the estimation is stopped in a case where a stop instruction is received from the user.

2. The information processing apparatus according to claim 1, wherein the estimation is an estimation of which of a plurality of environments corresponds to the use environment of the device, and wherein a setting associated with the estimated environment is applied to the device.

3. The information processing apparatus according to claim 1,
wherein the estimation is executed in a case where it is determined that connection states of a plurality of the network interfaces are the connected state, and is an estimation of which of a plurality of environments corresponds to the use environment of the device for each of the plurality of network interfaces, and
wherein, based on priority levels preset to the plurality of environments, it is determined which of the estimation results of the plurality of network interfaces is to be applied as the estimation result of the use environment of the device.

4. The information processing apparatus according to claim 1,
wherein the information processing apparatus stores a history of execution of estimation of the use environment of the device,
wherein for a network interface of which the connection state is determined to be the connected state, the result of estimation of the use environment of the device is stored, and
wherein for a network interface of which the connection state is determined to be the unconnected state, information indicating that the network interface is unconnected is stored.

5. The information processing apparatus according to claim 4,
wherein in a case where a network connection of a network interface is newly detected and information indicating that the network interface is unconnected is stored as the history of the network interface, an instruction to execute estimation of a use environment from the user is received,
wherein in a case where the instruction to execute the estimation of the use environment from the user is received, the use environment of the device is estimated, and
wherein in a case where an instruction to refuse execution of the estimation of the use environment from the user is received, an instruction to disconnect the network interface of which the network connection is newly detected is notified to the user.

6. The information processing apparatus according to claim 5, wherein the instruction to disconnect the network interface of which the network connection is newly detected is continuously notified until the disconnection of the network interface is detected.

7. The information processing apparatus according to claim 4, wherein in a case where the disconnection of the network interface of which the connection state is the connected state is detected, the history of the network interface is changed to the information indicating that the network interface is unconnected.

8. The information processing apparatus according to claim 4, wherein in startup of the information processing apparatus, before the network connection of the network interface of the device becomes detectable, the history of the network interface is changed to the information indicating the unconnected state.

9. The information processing apparatus according to claim 1,
wherein a network connected state is a link-up state in which the device is communicable with another device, and
wherein a network unconnected state and a network disconnected state are a link-down state in which the device is restricted from communication with another device.

10. The information processing apparatus according to claim 1, wherein at least traffic, destination IP address, communication source IP address, protocol, or IP header information is applied as the communication characteristic of the device.

11. A method of an information processing apparatus, the method comprising:
executing, based on a communication characteristic of a target device, estimation of a use environment of the device;
notifying a user of a result of the estimation of the use environment of the device; and
checking a connection state of a network interface of the device,
wherein, in a situation where it is determined that the connection state of the network interface is an unconnected state, the estimation is executed in a case where an execution instruction is received from a user, and the estimation is stopped in a case where a stop instruction is received from the user.

12. A non-transitory computer readable storage medium storing a computer program for executing a method of an information processing apparatus, the method comprising:
executing, based on a communication characteristic of a target device, estimation of a use environment of the device;
notifying a user of a result of the estimation of the use environment of the device; and
checking a connection state of a network interface of the device,
wherein, in a situation where it is determined that the connection state of the network interface is an unconnected state, the estimation is executed in a case where an execution instruction is received from a user, and the estimation is stopped in a case where a stop instruction is received from the user.
